(19) United States
(12) Patent Application Publication
(10) Pub. No.: US 2026/0326234 A1
(43) Pub. Date: Oct. 22, 2026

(54) LASER PROCESSING EQUIPMENT

(71) Applicant: PlayNitride Display Co., Ltd., Miaoli County (TW)

(72) Inventors: Yen-Mu CHEN, Miaoli County (TW); Chia-Ling CHANG, Miaoli County (TW); Chung-Wei TSAI, Miaoli County (TW)

(21) Appl. No.: 19/231,737

(22) Filed: Jun. 9, 2025

(30) Foreign Application Priority Data
Apr. 16, 2025 (TW) 114114458

(51) Int. Cl. B23K 26/067; B23K 26/06; B23K 26/062; B23K 26/066; B23K 26/073

(52) U.S. Cl. CPC B23K 26/0676; B23K 26/062; B23K 26/0643; B23K 26/066; B23K 26/073

(57) ABSTRACT

Laser processing equipment includes a laser light source, a first phase retarder, a patterned mask, and a beam splitter module. The first phase retarder is arranged on the optical path of a laser beam emitted from the laser light source. The patterned mask is arranged on the optical path downstream of the first phase retarder. The beam splitter module includes a first polarization beam splitter, a first beam splitter, and a beam splitter unit. The first polarization beam splitter splits the laser beam into a first polarization beam and a second polarization beam. The first beam splitter splits the first polarization beam into a first sub-beam and a second sub-beam. After passing through the beam splitter unit, the first sub-beam, the second sub-beam, and the second polarization beam form a plurality of separated processing beams, which project on different openings of the patterned mask and form separated light spots.

### CROSS REFERENCE TO RELATED APPLICATIONS

This Non-provisional application claims priority under 35 U.S.C. § 119(a) on Patent Application No(s). 114114458 filed in Taiwan, Republic of China on Apr. 16, 2025, the entire contents of which are hereby incorporated by reference.

### BACKGROUND

### Technology Field

The present disclosure relates to processing equipment and, in particular, to laser processing equipment used for the laser transfer process.

### Description of Related Art

Mass transfer is considered as a key technology for the mass production of Micro LEDs and is also an important factor affecting the process yield. Many manufacturers have invested in the development of mass transfer technology. Mass transfer technology is mainly divided into two modes: stamp transfer and laser transfer. Currently, most manufacturers choose the stamp transfer method because the stamp transfer technology is relatively mature, and the equipment cost for stamp transfer is low. However, the transfer efficiency of stamp transfer technology is low. Therefore, there are more equipment manufacturers paying their attention to the laser transfer method.

The transfer speed of laser transfer method is much faster than that of mechanical transfer method. In the laser transfer method, the material of the release layer (adhesive layer) can absorb the energy of the laser beam irradiated thereon, causing rapid evaporation and removal of the release layer, thereby separating the micro LED chips from the substrate. Afterwards, the chips can be peeled off and fall onto the corresponding position of the target substrate, thereby finishing the transfer of the chips.

However, in conventional laser transfer processes utilizing a mask imaging system, a single laser light source is typically required to cover the pattern with multiple openings on the mask. If the pitches between the openings are relatively larger (i.e., the pattern density is lower), the covering area of the laser beam must also be increased. As a result, the energy throughput of the laser beam passing through each opening is reduced accordingly. In addition, if multiple sets of laser light sources are used in combination with respective optical lenses and masks to form multiple laser beams that can be independently controlled, a corresponding number of laser light sources are required, which significantly increases the cost of the light sources.

### SUMMARY

An objective of this disclosure is to provide a laser processing equipment that can improve the energy throughput of laser beams passing through multiple openings on a patterned mask.

To achieve the above, the laser processing equipment of this disclosure includes a laser light source, a first phase retarder, a patterned mask, and a beam splitter module. The laser light source is configured for emitting a laser beam. The first phase retarder is arranged on an optical path of the laser beam. The patterned mask is arranged on the optical path of the laser beam downstream of the first phase retarder, and the patterned mask includes a plurality of openings. The beam splitter module is arranged between the first phase retarder and the patterned mask. The beam splitter module includes a first polarization beam splitter, a first beam splitter and a beam splitter unit. The first polarization beam splitter is arranged on the optical path of the laser beam downstream of the first phase retarder, and the first polarization beam splitter is configured for splitting the laser beam into a first polarization beam and a second polarization beam, which have different polarization directions. The first beam splitter is arranged on an optical path of the first polarization beam and is configured for splitting the first polarization beam into a first sub-beam reflected by the first beam splitter and a second sub-beam that transmits through the first beam splitter. The beam splitter unit is arranged on the optical path of the laser beam downstream of the first polarization beam splitter and the first beam splitter. The first sub-beam, the second sub-beam and the second polarization beam, after passing through the beam splitter unit, are formed into a plurality of separated processing beams, which project on different openings and form corresponding light spots.

As mentioned above, in the laser processing equipment of this disclosure, the first phase retarder is configured for rotating the polarization direction of the input laser beam, and the beam splitter module is configured for splitting the input laser beams into separated beams based on different polarization directions, which can be projected on different openings of the patterned mask so as to form corresponding light spots. Therefore, the laser processing equipment of this disclosure can split a single input laser beam into multiple separated processing beams, thereby improving the energy throughput of laser beams passing through multiple openings on the patterned mask.

In one embodiment, the configurations of the above components, along with phase retarders and polarization beam splitters, can improve the energy throughput of the laser beam passing through the multiple openings, and minimize the non-utilized energy of the laser beam, thereby reducing the loss of laser energy. In other words, this embodiment can increase the proportion of energy of the multiple light beams that pass through the patterned mask, thereby enhancing the utilization efficiency of the laser beam. In one embodiment, in addition to improving the energy throughput of the laser beam passing through the multiple openings, a single laser light source is employed to independently control the energy distribution of multiple split processing beams incident on multiple openings. In one embodiment, under conditions of minimal energy loss, the embodiment achieves maximized utilization of the beam energy. Since the energy throughput of the laser beam passing through the multiple openings can be effectively improved, not only the utilization efficiency of the laser beam energy can be improved, but also the transfer speed of the laser transfer process can be accelerated.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing the laser processing equipment according to an embodiment of this disclosure;

FIG. 2 to FIG. 5 are schematic diagrams showing the laser processing equipment according to different embodiments of this disclosure;

FIGS. 6A to 6C are schematic diagrams showing the laser processing equipment according to different embodiments of this disclosure;

FIG. 7 is a schematic diagram showing the laser processing equipment according to another embodiment of this disclosure; and

FIG. 8 is a schematic diagram showing the sizes of the light spots and the openings on the patterned mask according to the embodiment of this disclosure.

### DETAILED DESCRIPTION OF THE DISCLOSURE

The present disclosure will be apparent from the following detailed description, which proceeds with reference to the accompanying drawings, wherein the same references relate to the same elements. The elements or units shown in the drawings for explaining the present disclosure are merely schematic and do not represent the sizes and proportions of the actual elements or units.

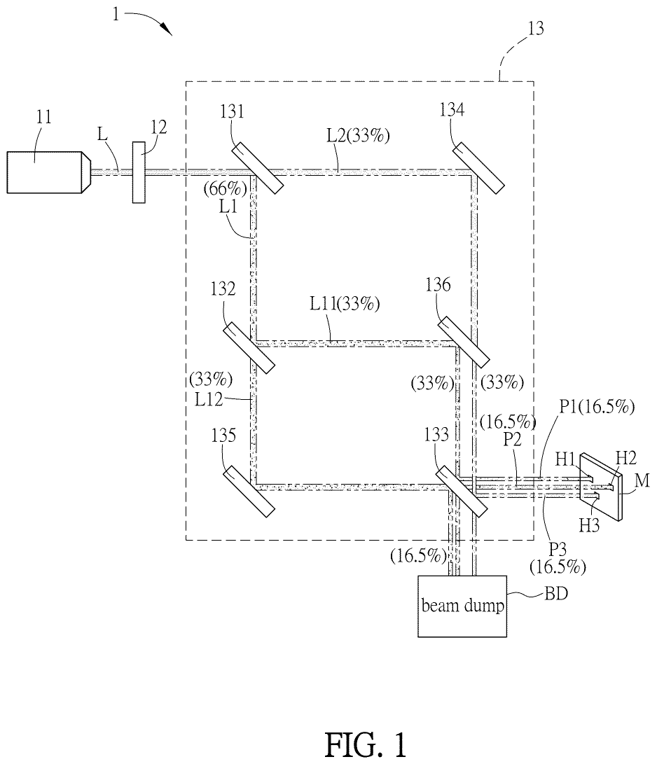

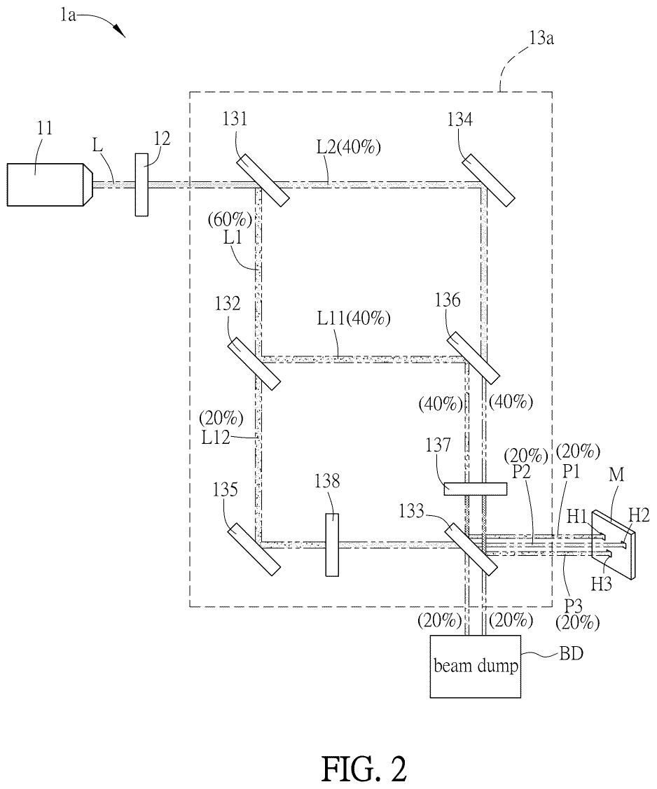

FIG. 1 is a schematic diagram showing the laser processing equipment according to an embodiment of this disclosure, and FIG. 2 to FIG. 7 are schematic diagrams showing the laser processing equipment according to different embodiments of this disclosure.

Referring to FIG. 1, the laser processing equipment 1 of this embodiment includes a laser light source 11, a first phase retarder 12, a patterned mask M, and a beam splitter module 13.

The laser light source 11 is configured for emitting a laser beam L. The first phase retarder 12 is arranged on an optical path of the laser beam L. In this embodiment, the first phase retarder 12 can rotate the polarization direction of the input laser beam L and split the laser beam L into an S-polarization beam and a P-polarization beam of different proportions. For example, the energy proportion of the S-polarization beam is 66%, and the energy proportion of the P-polarization beam is 33%. In detail, the S-polarization beam has an electric field vibration direction perpendicular to the plane of incidence and can be reflected by the polarization beam splitter (PBS). In contrast, the P-polarization beam has an electric field vibration direction parallel to the plane of incidence and can pass through the polarization beam splitter. In this embodiment, the first phase retarder 12 may be a waveplate such as, for example but not limited to, a half-waveplate.

The patterned mask M is arranged on the optical path of the laser beam L downstream of the first phase retarder 12 and the beam splitter module 13. The patterned mask M includes a plurality of openings. In this embodiment, the patterned mask M includes, for example, three openings H1, H2 and H3.

The beam splitter module 13 is arranged between the first phase retarder 12 and the patterned mask M. The beam splitter module 13 includes a first polarization beam splitter 131, a first beam splitter 132, and a beam splitter unit 133. In addition, the beam splitter module 13 of this embodiment may further include a first reflector 134, a second reflector 135, and a second polarization beam splitter 136.

The first polarization beam splitter 131 is arranged on the optical path of the laser beam L downstream of the first phase retarder 12. Since the first phase retarder 12 has rotated and split the laser beam L into the S-polarization beam and the P-polarization beam in different proportions, the first polarization beam splitter 131 can further split the laser beam L into a first polarization beam L1 (from the S-polarization beam, referring to FIG. 1) and a second polarization beam L2 (from the P-polarization beam, referring to FIG. 1). The first polarization beam L1 and the second polarization beam L2 have different polarization directions.

The first beam splitter 132 is arranged on an optical path of the first polarization beam L1. In this embodiment, the first beam splitter 132 is configured for splitting the first polarization beam L1 into a first sub-beam L11 reflected by the first beam splitter 132 and a second sub-beam L12 that transmits through the first beam splitter 132.

The first reflector 134 is arranged between the first polarization beam splitter 131 and the beam splitter unit 133 and located on an optical path of the second polarization beam L2. In this embodiment, the first reflector 134 is arranged between the first polarization beam splitter 131 and the second polarization beam splitter 136. The second reflector 135 is arranged between the first beam splitter 132 and the beam splitter unit 133 and located on an optical path of the second sub-beam L12. The first reflector 134 and the second reflector 135 are configured to respectively reflects the second polarization beam L2 and the second sub-beam L12, thereby guiding the optical paths to the beam splitter unit 133 arranged at the intersection of the first sub-beam L11, the second sub-beam L12 and the second polarization beam L2.

The second polarization beam splitter 136 is arranged between the first beam splitter 132, the first reflector 134, and the beam splitter unit 133, and the second polarization beam splitter 136 is located at the intersection of the second polarization beam L2 and the first sub-beam L11. In this embodiment, the second polarization beam splitter 136 is configured to allow the second polarization beam L2 to pass through and reflect the first sub-beam L11, thereby directing both beams toward the beam splitter unit 133.

The beam splitter unit 133 is arranged on the optical path of the laser beam L downstream of the first polarization beam splitter 131, the first beam splitter 132, and the second polarization beam splitter 136. The first sub-beam L11, the second sub-beam L12, and the second polarization beam L2, after passing through the beam splitter unit 133, are formed into a plurality of separated processing beams. In this embodiment, for example, there are three processing beams P1, P2 and P3 formed after the beam splitter unit 133. The three processing beams P1, P2 and P3 can project on three openings H1, H2 and H3 of the patterned mask M, respectively, and form corresponding light spots. In one embodiment, the three light spots are spatially separated and do not overlap with each other.

In this embodiment, the beam splitter unit 133 is a beam splitter, such as, for example but not limited to, a 50/50 beam splitter, which is disposed at the intersection of three beams (including the first sub-beam L11, the second sub-beam L12, and the second polarization beam L2). Due to the difference in incident directions between the two beams from the second polarization beam splitter 136 (including the first sub-beam L11 and the second polarization beam L2) and the second sub-beam L12 from the second reflector 135, the present embodiment provides a beam splitter unit 133 (beam splitter) to ensure that all three beams are incident on the patterned mask M along a common incidence direction. In this case, the arrangement of the beam splitter unit 133 allows a portion of each beam to pass through and reach the patterned mask M, while another portion of each beam is reflected by the beam splitter unit 133 toward the patterned mask M. Although the configuration of the beam splitter unit 133 (beam splitter) results in a partial loss of energy, it enables the three processing beams P1, P2 and P3, which are formed by the three beams with different incident directions, to pass through the beam splitter unit 133 (beam splitter) and smoothly converge at the openings H1, H2 and H3 of the patterned mask M, thereby forming corresponding light spots respectively. These light spots can be respectively irradiated on the release layer (adhesive layer) between the micro LED chips and the substrate, so that the release layer can be removed to complete the transfer process of the chips.

In this embodiment, for example, the energy of the first polarization beam L1 is 66% of the energy of the laser beam L, and the energy of the second polarization beam L2 is 33% of the energy of the laser beam L. To be noted, this disclosure is not limited thereto. In another embodiment, the energy proportions of the first polarization beam L1 and the second polarization beam L2 may vary depending on the rotation angle of the first phase retarder 12 relative to the polarization direction of the laser beam L. In addition, in some embodiments, the first beam splitter 132 may be, for example, a 50/50 beam splitter, which may split the first polarization beam L1 into two beams with equal energy to achieve a uniform energy division, but the present disclosure is not limited thereto. In some embodiments, the energy of the first sub-beam L11 reflected by the first beam splitter 132 may be, for example, 33% of the energy of the laser beam L, and the energy of the second sub-beam L12 passing through the first beam splitter 132 may be, for example, 33% of the energy of the laser beam L. To be noted, this disclosure is not limited thereto the above. In practice, the beam splitter with different splitting ratio may be used according to actual conditions to achieve different energy distribution. In addition, in this embodiment, the energy of the first sub-beam L11 after passing through the second polarization beam splitter 136 is, for example, 33% of the energy of the laser beam L, and the energy of the second polarization beam L2 passing through the second polarization beam splitter 136 is, for example, 33% of the energy of the laser beam L. In this embodiment, the energies of the processing beams P1, P2 and P3 are the same. The energy of each processing beam P1, P2 or P3 is, for example, 16.5% of energy of the laser beam L. In other words, the total energy of the processing beams P1, P2 and P3, which are projected on the patterned mask M after passing through the beam splitter module 13, to be applied for the subsequent processes is 49.5% of the original energy of the laser beam L.

In addition, a part of the first sub-beam L11 being from the second polarization beam splitter 136 and passing through the beam splitter unit 133 (e.g. having an energy proportion of 16.5%), a part of the second sub-beam L12 being from the second reflector 135 and reflected by the beam splitter unit 133 (e.g. having an energy proportion of 16.5%), and a part of the second polarization beam L2 being from the second polarization beam splitter 136 and passing through the beam splitter unit 133 (e.g. having an energy proportion of 16.5%) will enter the beam dump BD, thereby blocking the redundant beams or absorbing the redundant energy by heat dissipation. To be noted, this disclosure is not limited to the heat dissipation method.

As mentioned above, in the laser processing equipment 1 of this embodiment, the first phase retarder 12 can rotate the polarization direction of the input laser beam L, the first polarization beam splitter 131 can separate the S-polarization beam and the P-polarization beam, and the first beam splitter 132 can split the S-polarization beam into two beams. After the guidance of the first reflector 134 and the second reflector 135 and the beam splitting of the second polarization beam splitter 136, the three beams (including the first sub-beam L11, the second sub-beam L12 and the second polarization beam L2) can be guided to the beam splitter unit 133 (beam splitter) disposed at the intersection of the three beams, so that the three beams can smoothly reach the patterned mask M and converge on the openings H1, H2 and H3, respectively, to form corresponding light spots. This design can divide the single laser beam L emitted from one single laser light source 11 into multiple processing beams P1, P2 and P3, thereby improving the energy throughput of the laser beam L passing through the multiple openings H1, H2 and H3 of the patterned mask M. In addition, the laser processing equipment 1 of this embodiment can control the energy intensities of the three processing beams P1, P2 and P3 through the combination of one laser beam L, the first phase retarder 12, and the beam splitter module 13, thereby performing the distribution of the energy proportion from the single laser beam L.

In one embodiment, the processing beams P1, P2 and P3 can be parallel to each other, and the propagation directions of the processing beam P1, P2 and P3 are parallel to the surface normal vector of the patterned mask M. In this way, this disclosure can reduce the angular deviation of the processing beams P1, P2 and P3 incident on the patterned mask M, which reduces the complexity of subsequent processing steps. Furthermore, it can also diminish the effect caused by the asymmetric diffraction, which in turn improves the accuracy of the transferred pattern. In another embodiment, the processing beams P1, P2 and P3 may be non-parallel to each other, so that the beam direction or angle can have a fine-tuning to fit different shapes of the openings H1, H2 and H3 of the patterned mask M or different shapes of the workpieces, thereby improving processing flexibility.

The component configurations and connections of the laser processing equipment 1a according to another embodiment as shown in FIG. 2 are mostly the same as those of the laser processing equipment 1 of the previous embodiment. Differing from the laser processing equipment 1, the beam splitter unit 133 of the beam splitter module 13a of the laser processing equipment 1a is a polarization beam splitter. Moreover, in addition to the first polarization beam splitter 131, the first beam splitter 132, the first reflector 134, the second reflector 135 and the second polarization beam splitter 136, the beam splitter module 13a further includes a second phase retarder 137 and a third phase retarder 138.

The second phase retarder 137 is disposed between the second polarization beam splitter 136 and the beam splitter unit 133 (polarization beam splitter) and is located on the optical paths of the second polarization beam L2 and the first sub-beam L11 toward the beam splitter unit 133 (polarization beam splitter). In this embodiment, the second phase retarder 137 can rotate the polarization directions of the two beams (L11 and L2), so that the angle between the polarization direction of the two beams and the splitting axis of the beam splitter unit 133 (polarization beam splitter) is, for example, 45 degrees. Then, the beam splitter unit 133 (polarization beam splitter) can split each of the two linear polarization beams into an S-polarization beam and a P-polarization beam, each having, for example, equal energy (the energy of each split beam is 20%).

The third phase retarder 138 is arranged between the second reflector 135 and the beam splitter unit 133 (polarization beam splitter) and located on the optical path of the second sub-beam L12. The third phase retarder 138 can adjust the S-polarization beam (the second sub-beam L12) into a P-polarization beam, which can pass through the beam splitter unit 133 (polarization beam splitter) and reach the patterned mask M. In this embodiment, the energy of the second sub-beam L12 can be fully preserved through the configuration of the third phase retarder 138, thereby reducing the energy loss of the laser beam L during the splitting process.

In this embodiment, the first phase retarder 12 divides the laser beam L into an S-polarization beam and a P-polarization beam in different proportions (for example, the energy of the S-polarization beam is 60%, and the energy of the P-polarization beam is 40%). Therefore, the energy of the first polarization beam L1 (S-polarization beam) is, for example, 60% of the energy of the laser beam L, and the energy of the second polarization beam L2 is, for example, 40% of the energy of the laser beam L. In addition, the first beam splitter 132 of the present embodiment is a non-equivalent proportion beam splitter, which separates the S-polarization beam into two beams with unequal energies, in order to ensure that the energies of the processing beams transmitted to the patterned mask M can be equal. In this case, the energy of the first sub-beam L11 reflected by the first beam splitter 132 is, for example, 40% of the energy of the laser beam L, and the energy of the second sub-beam L12 passing through the first beam splitter 132 is, for example, 20% of the energy of the laser beam L. To be noted, this disclosure is not limited thereto, and the proportion distributions can be adjusted according to actual needs.

Compared with the laser processing equipment 1 of the previous embodiment, the laser processing equipment 1a of this embodiment can increase the proportion of the total energy projected to the patterned mask M. Specifically, in the laser processing equipment 1, the total energy of the processing beams P1, P2 and P3 is 49.5% of the original energy of the laser beam L (i.e., the energy of each of the three processing beams P1, P2 and P3 is 16.5% of the original energy of the laser beam L). In the current embodiment, the energy of each of the processing beams P1, P2 and P3 is, for example, 20% of the original energy of the laser beam L, and the total energy of the processing beams P1, P2 and P3 transmitted to the patterned mask M is 60% of the original energy of the laser beam L (i.e., the energy of each of the processing beams P1, P2 and P3 is increased to 20% of the original energy of the laser beam L). Therefore, the laser processing equipment 1a (including the beam splitter module 13a) can reduce energy loss during the beam splitting process, thereby minimizing the proportion of the non-utilized energy from the laser beam L. As a result, it increases the proportion of the energy of the three beams (P1, P2 and P3) projected to the patterned mask M and enhances the amount of energy available for subsequent processes.

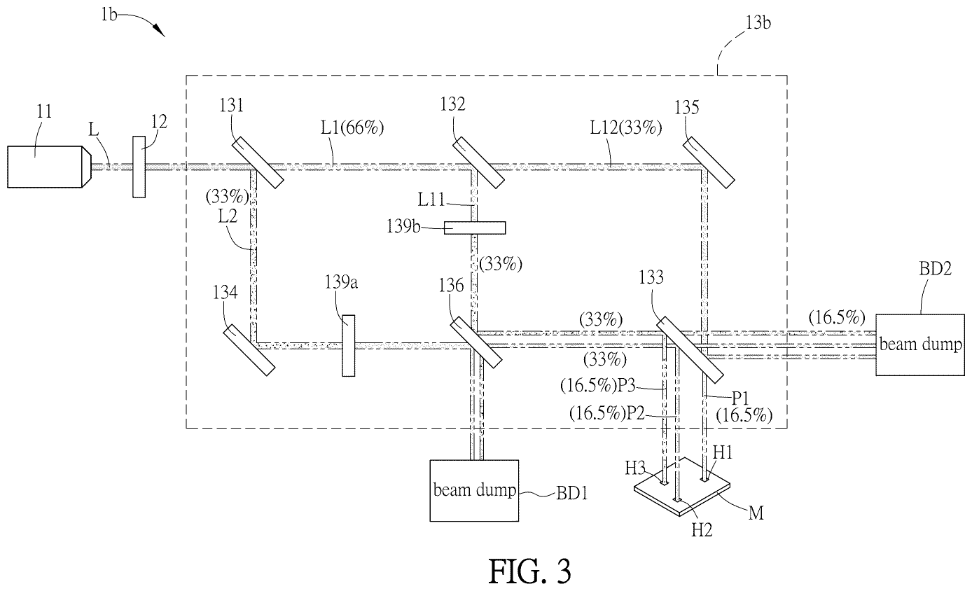

The component configurations and connections of the laser processing equipment 1b according to another embodiment as shown in FIG. 3 are mostly the same as those of the laser processing equipment 1 of the previous embodiment. Differing from the laser processing equipment 1, in addition to the first polarization beam splitter 131, the first beam splitter 132, the beam splitter unit 133, the first reflector 134, the second reflector 135 and the second polarization beam splitter 136, the beam splitter module 13b of the laser processing equipment 1b further includes two fourth phase retarders 139a and 139b. The fourth phase retarder 139a is arranged on the optical path of the second polarization beam L2 toward the second polarization beam splitter 136, and the fourth phase retarder 139b is arranged on the optical path of the first sub-beam L11 toward the second polarization beam splitter 136. The configuration of the fourth phase retarders 139a and 139b provides two functions. The first function is to rotate the polarization direction of the beams, so that the two beams can pass through the second polarization beam splitter 136 or be reflected by the second polarization beam splitter 136. The second function is to independently control the proportions of the energies of the two beams passing through the second polarization beam splitter 136.

In this embodiment, the first beam splitter 132 may be, for example, a 50/50 beam splitter, which splits the first polarization beam L1 (P-polarization beam) into two beams, thereby achieving the effect of evenly distributing the energy of the beams. To be noted, this disclosure is not limited thereto. In addition to that, the P-polarization beam of the second polarization beam L2 from the fourth phase retarder 139a may pass through the second polarization beam splitter 136, and the S-polarization beam of the first sub-beam L11 from the fourth phase retarder 139b may be reflected by the second polarization beam splitter 136. Furthermore, the S-polarization beam of the second polarization beam L2 from the fourth phase retarder 139a and the P-polarization beam of the first sub-beam L11 from the fourth phase retarder 139b are individually output to the beam dump BD1, which can block the redundant beams or absorb the redundant energy by, for example, heat dissipation method. To be noted, this disclosure is not limited to the heat dissipation method.

In summary, the laser processing equipment 1b of this embodiment is further configured with the fourth phase retarders 139a and 139b, enabling not only an increase in the energy throughput of the laser beam L passing through the multiple openings H1, H2 and H3, but also independent control of the energy proportion of each of the processing beams P1, P2 and P3 through a single laser light source 11. Specifically, the single laser beam L emitted by a single laser light source 11 can be divided into multiple processing beams (P1, P2 and P3), and the energy proportions of the three processing beams P1, P2 and P3 projecting onto the patterned mask M can be independently controlled. In this way, the energies can be adjusted according to the different process requirements of the workpieces, thereby improving the process flexibility. In this embodiment, the energy of each of the processing beams P1, P2 and P3 is, for example, 16.5% of the original energy of the laser beam L. In some embodiments, the energies of the three processing beams P1, P2 and P3 may be different and may be controlled individually by the first phase retarder 12 and the fourth phase retarders 139a and 139b.

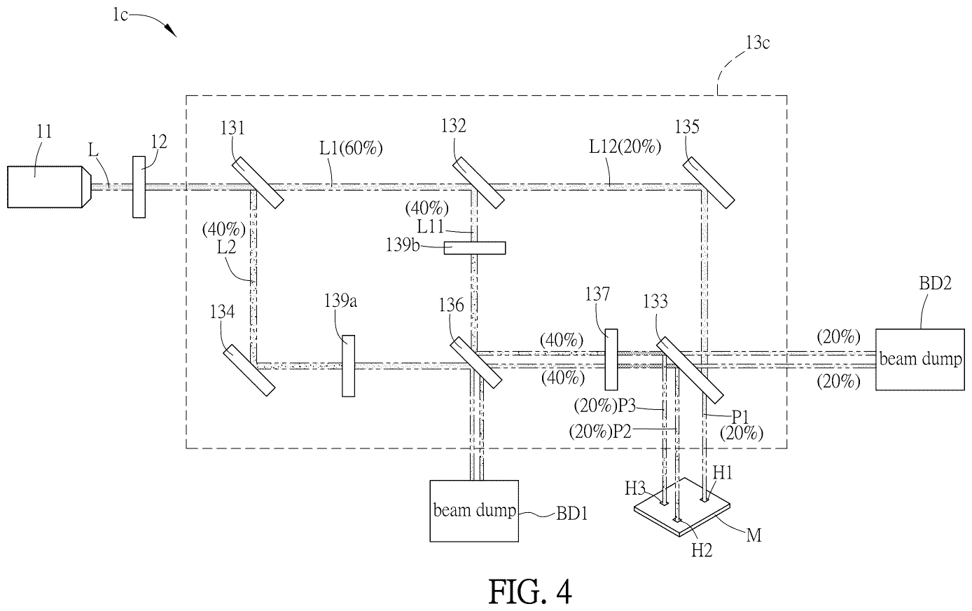

The component configurations and connections of the laser processing equipment 1c according to another embodiment as shown in FIG. 4 are mostly the same as those of the laser processing equipment 1b of the previous embodiment. Differing from the laser processing equipment 1b, the beam splitter unit 133 of the beam splitter module 13c of the laser processing equipment 1c is a polarization beam splitter. Moreover, in addition to the first polarization beam splitter 131, the first beam splitter 132, the beam splitter unit 133 (polarization beam splitter), the first reflector 134, the second reflector 135, the second polarization beam splitter 136, and the fourth phase retarders 139a and 139b, the beam splitter module 13c further includes a second phase retarder 137. The second phase retarder 137 is disposed between the second polarization beam splitter 136 and the beam splitter unit 133 (polarization beam splitter) and is located on the optical paths of the second polarization beam L2 and the first sub-beam L11 toward the beam splitter unit 133 (polarization beam splitter).

In this embodiment, the energy of the first polarization beam L1 is, for example, 60% of the energy of the laser beam L, and the energy of the second polarization beam L2 is, for example, 40% of the energy of the laser beam L. The first beam splitter 132 is, for example, a non-equivalent proportion beam splitter, which is arranged on the optical path of the first polarization beam L1 (P-polarization beam) for distributing (controlling) the energies of the first sub-beam L11 and the second sub-beamL12. For example, after the energy distribution, the energy of the first sub-beam L11 is 40% of the energy of the laser beam L, and the energy of the second sub-beam L12 is 20% of the energy of the laser beam L. In this case, the energy distribution serves to equalize the energy proportions of the processing beams P1, P2 and P3 that are ultimately transmitted to the patterned mask M. For example, the energy of each of the processing beams P1, P2 and P3 transmitted to the patterned mask M is 20% of the original energy of the laser beam L. To be noted, this disclosure is not limited thereto.

Therefore, due to the configuration of the first phase retarder 12 and the fourth phase retarders 139a and 139b, the laser processing equipment 1c of this embodiment can independently control the proportions of the energies of the three processing beams P1, P2 and P3. In addition, the configuration of the second phase retarder 137 can reduce the energy loss of the laser beam L during the splitting process, thereby enhancing the available proportion of the laser beam energy. Therefore, the laser processing equipment 1c of this embodiment can split one laser beam L emitted from a single light source into three processing beams P1, P2 and P3 to maximize the utilization of the energy of the laser beam L, and can further independently control the energies of the three processing beams P1, P2 and P3 to meet different requirements of subsequent processes, which also improves the process flexibility.

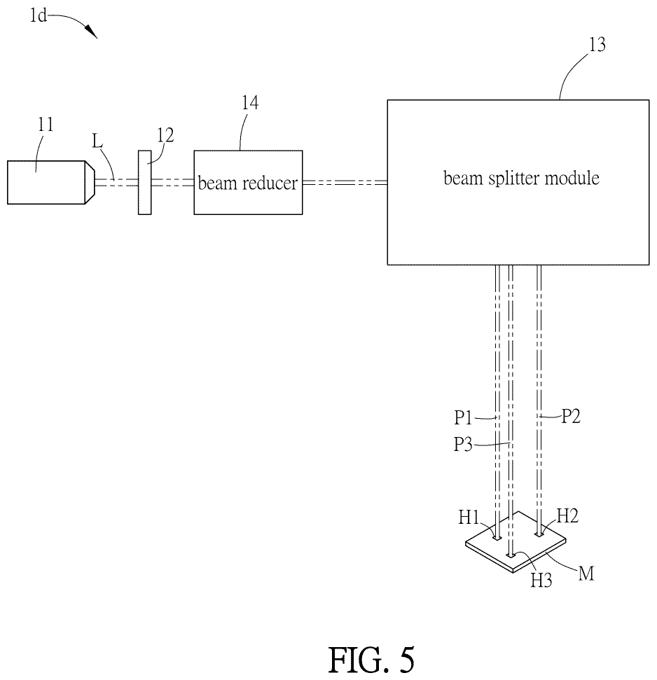

The component configurations and connections of the laser processing equipment 1d according to another embodiment as shown in FIG. 5 are mostly the same as those of the laser processing equipment of the previous embodiments. Differing from the previous laser processing equipment, the laser processing equipment 1d further includes at least one beam reducer 14, which is arranged between the laser light source 11 and the patterned mask M, and located on the optical path of the laser beam L toward the patterned mask M.

In this embodiment, the laser processing equipment 1d includes one beam reducer 14, which is arranged between the first phase retarder 12 and the beam splitter module 13 and located on the optical path of the laser beam L toward the beam splitter module 13. To be noted, this disclosure is not limited thereto. In other embodiments, the beam reducer 14 can, for example but not limited to, be arranged between the laser light source 11 and the first phase retarder 12, or between and the beam splitter module 13 and the patterned mask M.

The beam reducer 14 can be used to reduce the cross-sectional size of the laser beam L (i.e., the light spot area) by being arranged on the optical path of the laser beam L toward the patterned mask M, so that the spot size can be adjusted to match the size of the opening on the patterned mask M and completely covering it. In addition, for condensing the light spot size to increase the optical power density of the laser beam. Therefore, the beam reducer 14 can perform the functions of concentrating the energy of the laser beam. As a result, the condensed light spot of the laser beam can be accurately focused on a specific portion of the workpiece to be processed by passing through the openings on the patterned mask M.

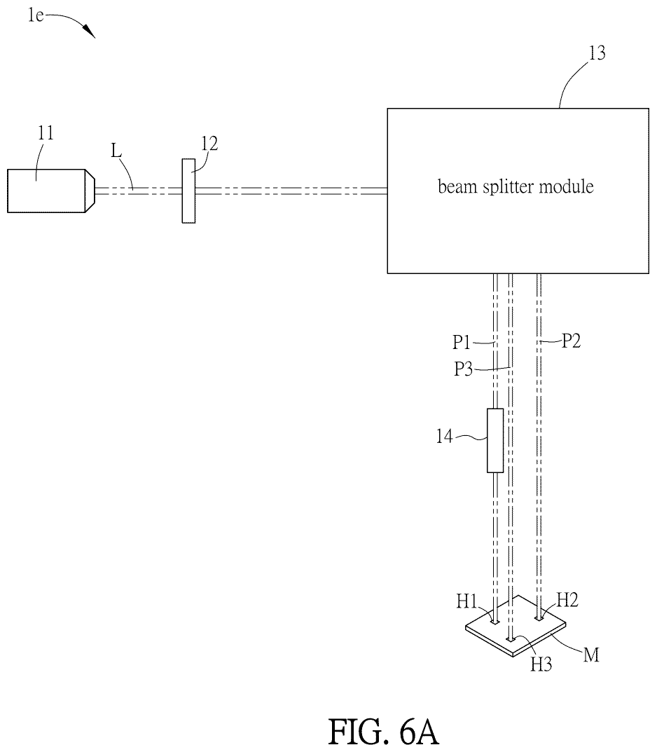

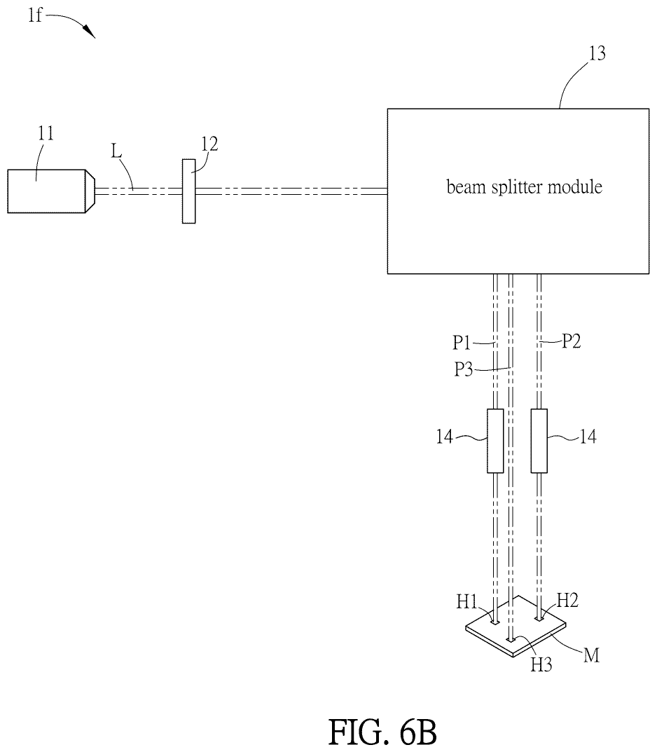

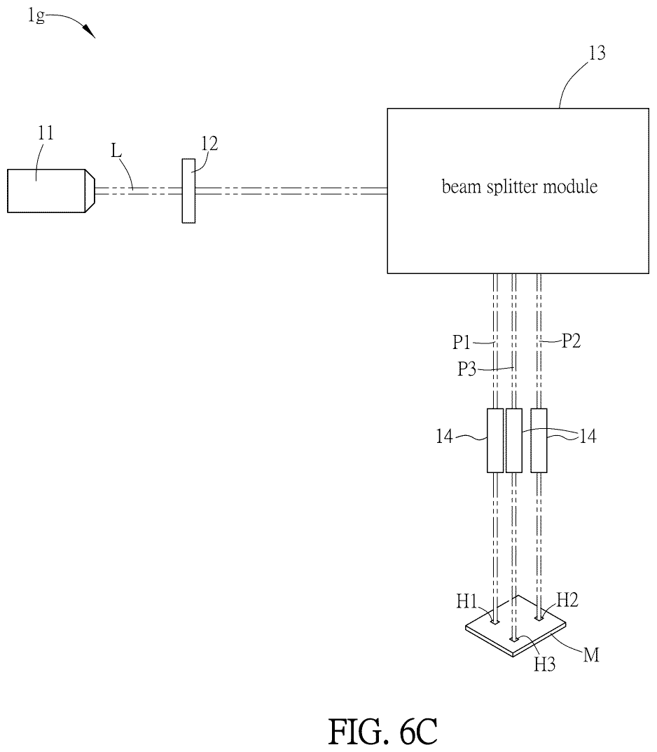

The component configurations and connections of the laser processing equipment 1e according to another embodiment as shown in FIG. 6A are mostly the same as those of the laser processing equipment 1d of the previous embodiments. Differing from the previous laser processing equipment 1d, the beam reducer 14 of the laser processing equipment 1e is arranged between the beam splitter module 13 (or the beam splitter unit 133) and the patterned mask M, and located on the optical path of one of the processing beams (e.g. the processing beam P1) toward the patterned mask M.

Referring to FIG. 6B, the laser processing equipment 1f includes two beam reducers 14, which are arranged between the beam splitter module 13 (or the beam splitter unit 133) and the patterned mask M, and located on the optical paths of two of the processing beams (e.g. the processing beams P1 and P2), respectively, toward the patterned mask M.

Referring to FIG. 6C, the laser processing equipment 1g includes three beam reducers 14, which are arranged between the beam splitter module 13 (or the beam splitter unit 133) and the patterned mask M, and located on the optical paths of the three processing beams P1, P2 and P3, respectively, toward the patterned mask M.

In brief, there may be three situations when the beam reducer(s) 14 is(are) provided on the optical path(s) of the processing beam(s) toward the patterned mask M. In the first situation, one beam reducer 14 is located on the optical path of one of the processing beams (see FIG. 6A), so that only the light spot area of one of the processing beams is reduced. In the second situation, some of the processing beams pass through the beam reducers 14. For example, two of the processing beams pass through the beam reducers 14 (see FIG. 6B), so that only the light spot areas of the two processing beams are reduced, while the other one processing beam does not pass through the beam reducer 14, so that its light spot area is not changed. In this case, the light spot areas formed by the three processing beams P1, P2 and P3 are not all the same. In the third situation, all three processing beams P1, P2 and P3 correspond to different beam reducers 14 (e.g. three beam reducers 14) respectively (see FIG. 6C), so that the areas of the three light spots can be adjusted independently through the three beam reducers 14. In this case, the three beam reducers 14 can independently adjust the areas of the three light spots, and the areas of the three light spots can be, for example but not limited to, the same or different from each other.

In some embodiments, the reduction factor of the beam reducer 14 may be, for example, between 5 and 20 times. In some embodiments, the beam reducer 14 can be a transmissive beam reducer or a reflective beam reducer, but this disclosure is not limited thereto. The transmissive beam reducer is suitable for the light beam with a single wavelength or a narrow bandwidth (the wavelength width Δλ is between 1 and 10 nm). On the other hand, the reflective beam reducer may be, for example, a set of off-axis parabolic mirrors (OAP), but this disclosure is not limited thereto. The reflective beam reducer is suitable for the light beam with broad-spectrum wavelength (e.g. broad-area laser) or long wavelength (e.g. CO₂ laser). Compared with the transmissive beam reducer, the reflective beam reducer has the following functions. 1. There is no spherical aberration, so that the processing beam can focus on a single focal point with high precision, which maintains the shape of the light spot and ensures uniform distribution of energy. 2. There is no chromatic aberration, so that the processing beam is not affected by refractive index, and the processing beams of different wavelengths can be focused on the same focal point. 3. The energy loss can be reduced.

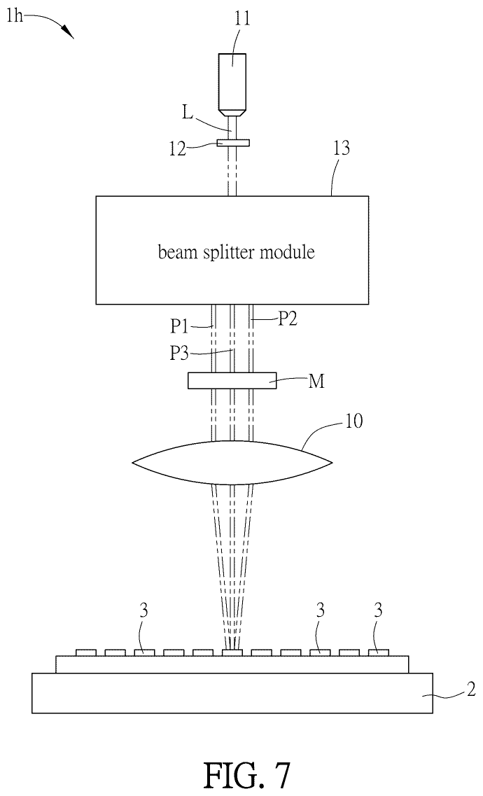

The component configurations and connections of the laser processing equipment 1h according to another embodiment as shown in FIG. 7 are mostly the same as those of the laser processing equipment of the previous embodiments. Differing from the previous laser processing equipment, the patterned mask M of the laser processing equipment 1h is arranged between the beam splitter module 13 and a carrier stage 2. The carrier stage 2 is configured to carry a plurality of workpieces 3, which are separately arranged on the carrier stage 2, and located on the optical paths of the processing beams P1, P2 and P3 downstream of the patterned mask M. The light spots formed by the aforementioned processing beams P1, P2 and P3 may focus on at least one workpiece 3. In this case, the workpiece 3 may be, for example, an LED chip, such as, for example but not limited to, a micro LED chip, and may be a single pixel. For example, one pixel may include three sub-pixels (e.g. R, G and B sub-pixels), and the light spots formed by the processing beams P1, P2 and P3 may focus on the three sub-pixels, respectively. To be noted, this disclosure is not limited thereto.

In addition, the laser processing equipment 1h of this embodiment may further include a focusing element 10. The focusing element 10 is arranged between the patterned mask M and the workpiece 3. For example, the focusing element 10 can be a lens for focusing the processing beams P1, P2 and P3 on at least one workpiece 3.

To be noted, each laser processing equipment 1d~1h as shown in FIGS. 5 to 7 includes the beam splitter module 13 as shown in FIG. 1. In other embodiments, the beam splitter module 13 of one of the laser processing equipment 1d~1h as shown in FIGS. 5 to 7 can be substituted by any one of the above-mentioned beam splitter modules 13a, 13b and 13c.

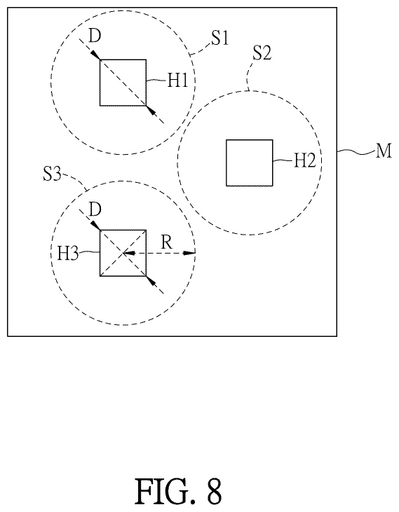

FIG. 8 is a schematic diagram showing the sizes of the light spots and the openings on the patterned mask according to the embodiment of this disclosure. In some embodiments, as shown in FIG. 8, the shape of the openings H1, H2 and H3 may be square, and the shape of the light spots S1, S2 and S3 may be circular. In this case, each opening H1, H2 or H3 has a maximum width D, and the radius R of each light spot S1, S2 or S3 may be between 0.5 times and 3 times of the maximum width D (0.5D≤R≤3D). The maximum width D is defined as the distance between the two farthest points along the edge of the opening H1, H2 or H3, and the center of each light spot S1, S2 or S3 is overlapped with the midpoint of the maximum width D of each opening H1, H2 or H3. In one embodiment, the minimum diameter of each light spot S1, S2 or S3 is equal to the maximum width D of each opening H1, H2 or H3.

In some embodiments, if the laser light source 11 emits a flat-top laser beam, the size of the light spot is equal to the area of the light spots formed by the processing beams P1, P2 and P3. In some embodiments, if the laser light source 11 emits a Gaussian laser beam, the FWHM (full width at half maximum) area of the light spot is equal to the area of the light spots formed by the processing beams P1, P2 and P3. To be noted, regardless of whether the laser light source 11 emits a flat-top laser beam or a Gaussian laser beam, the corresponding light spots formed by the processing beams P1, P2 and P3 must completely cover the openings H1, H2 and H3, respectively.

In summary, in the laser processing equipment of this disclosure, the first phase retarder is configured for rotating the polarization direction of the input laser beam, and the beam splitter module is configured for splitting the input laser beams into separated beams based on different polarization directions, which can be projected on different openings of the patterned mask so as to form corresponding light spots. Therefore, the laser processing equipment of this disclosure can split a single input laser beam into multiple separated processing beams, thereby improving the energy throughput of laser beams passing through multiple openings on the patterned mask.

In one embodiment, the configurations of the above components, along with phase retarders and polarization beam splitters, can improve the energy throughput of the laser beam passing through the multiple openings, and minimize the non-utilized energy of the laser beam, thereby reducing the loss of laser energy. In other words, this embodiment can increase the proportion of energy of the multiple light beams that pass through the patterned mask, thereby enhancing the utilization efficiency of the laser beam. In one embodiment, in addition to improving the energy throughput of the laser beam passing through the multiple openings, a single laser light source is employed to independently control the energy distribution of multiple spilt processing beams incident on multiple openings. In one embodiment, under conditions of minimal energy loss, the embodiment achieves maximized utilization of the beam energy. Since the energy throughput of the laser beam passing through the multiple openings can be effectively improved, not only the utilization efficiency of the laser beam energy can be improved, but also the transfer speed of the laser transfer process can be accelerated.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. Laser processing equipment, comprising:
a laser light source configured for emitting a laser beam;
a first phase retarder arranged on an optical path of the laser beam;
a patterned mask arranged on the optical path of the laser beam downstream of the first phase retarder, wherein the patterned mask comprises a plurality of openings; and
a beam splitter module arranged between the first phase retarder and the patterned mask, wherein the beam splitter module comprises:
a first polarization beam splitter arranged on the optical path of the laser beam downstream of the first phase retarder, wherein the first polarization beam splitter is configured for splitting the laser beam into a first polarization beam and a second polarization beam, and the first polarization beam and the second polarization beam have different polarization directions;
a first beam splitter arranged on an optical path of the first polarization beam, wherein the first beam splitter is configured for splitting the first polarization beam into a first sub-beam reflected by the first beam splitter and a second sub-beam that transmits through the first beam splitter; and
a beam splitter unit arranged on the optical path of the laser beam downstream of the first polarization beam splitter and the first beam splitter, wherein the first sub-beam, the second sub-beam and the second polarization beam, after passing through the beam splitter unit, are formed into a plurality of separated processing beams, which project on different ones of the openings and form corresponding light spots.

2. The laser processing equipment of claim 1, wherein the beam splitter module further comprises:
a first reflector arranged between the first polarization beam splitter and the beam splitter unit and located on an optical path of the second polarization beam; and
a second reflector arranged between the first beam splitter and the beam splitter unit and located on an optical path of the second sub-beam;
wherein, the first reflector and the second reflector respectively reflect the second polarization beam and the second sub-beam to the beam splitter unit.

3. The laser processing equipment of claim 2, wherein the beam splitter module further comprises:
a second polarization beam splitter arranged between the first beam splitter, the first reflector and the beam splitter unit, and located at an intersection of the second polarization beam and the first sub-beam.

4. The laser processing equipment of claim 3, wherein the beam splitter unit is a polarization beam splitter, and the beam splitter module further comprises:
a second phase retarder arranged between the second polarization beam splitter and the beam splitter unit, and located on the optical path of the second polarization beam and an optical path of the first sub-beam toward the beam splitter unit.

5. The laser processing equipment of claim 4, wherein the beam splitter module further comprises:
a third phase retarder arranged between the second reflector and the beam splitter unit, and located on the optical path of the second sub-beam.

6. The laser processing equipment of claim 4, wherein the beam splitter module further comprises:
two fourth phase retarders arranged on the optical paths of the second polarization beam and the first sub-beam toward the second polarization beam splitter.

7. The laser processing equipment of claim 3, wherein the beam splitter module further comprises:
two fourth phase retarders arranged on the optical path of the second polarization beam and an optical path of the first sub-beam toward the second polarization beam splitter.

8. The laser processing equipment of claim 1, wherein the processing beams are parallel to each other, and the propagation direction of each the processing beams is parallel to a surface normal vector of the patterned mask.

9. The laser processing equipment of claim 1, wherein the processing beams are not parallel to each other.

10. The laser processing equipment of claim 1, wherein the processing beams have different light intensities.

11. The laser processing equipment of claim 1, wherein the light spots are separated.

12. The laser processing equipment of claim 1, further comprising:
at least a beam reducer arranged between the laser light source and the patterned mask, and located on the optical path of the laser beam toward the patterned mask.

13. The laser processing equipment of claim 12, wherein the beam reducer is arranged between the beam splitter unit and the patterned mask, and located on an optical path of one of the processing beams toward the patterned mask.

14. The laser processing equipment of claim 13, wherein the laser processing equipment comprises a plurality of the beam reducers, each corresponding to the processing beams respectively, and the light spots have different areas.

15. The laser processing equipment of claim 1, wherein the patterned mask is arranged between the beam splitter module and a carrier stage, the carrier stage is configured to carry a plurality of workpieces, and the light spots fall on at least one of the workpieces.

16. The laser processing equipment of claim 1, wherein each of the openings has a maximum width, and each of the light spots has a radius between 0.5 and 3 times of the maximum width.
